(19) United States
(12) Patent Application Publication
(10) Pub. No.: US 2007/0271390 A1
(43) Pub. Date: Nov. 22, 2007

(54) Intelligent top-level domain (TLD) and protocol/scheme selection in direct navigation

(76) Inventors: Michael Landau, Greenbrae, CA (US); Evan Horowitz, San Francisco, CA (US)

Correspondence Address: PERKINS COIE LLP, P.O. BOX 2168, MENLO PARK, CA, 94026, US

(21) Appl. No.: 11/438,087

(22) Filed: May 19, 2006

(51) Int. Cl. G06F 15/173

(52) U.S. Cl. 709/238

(57) ABSTRACT

A system, method, and computer program are provided for improved top-level domain (TLD) and protocol/scheme selection during URL formation initiated via direct navigation techniques. As appropriate, intelligent URL construction mechanisms operate by 1) analyzing the available geolocational and lexical information related to the direct navigation instance, and 2) choosing an appropriate TLD and/or protocol/scheme based on the analysis performed.

### CROSS-REFERENCE TO RELATED APPLICATIONS

U.S. Pat. No. 6,684,250 Anderson, et al.

### Method and apparatus for estimating a geographic location of a networked entity.

U.S. Patent Application Publication 2003/0182447 Schilling, et al.

### Generic top-level domain re-routing system.

U.S. Patent Application Publication 2003/0191647 Kam, et al.

### Method & system for managing web pages, and telecommunications via multilingual keywords and domains.

U.S. Patent Application Publication 2005/0071417 Taylor, et al.

### Method and apparatus for geolocation of a network user.□

### PRIOR ART

Firefox Web Browser:

http://Mozilla.com/

RealNames Keyword Service:

http://RealNames.com/

Geo-Location Service Providers:

http://MaxMind.com/
http://HostIP.info/
http://ip2Location.com/

Google Toolbar:

http://toolbar.google.com/

### BACKGROUND OF THE INVENTION

1. Field of the Invention

The present invention relates to network navigation mechanisms, and more particularly to improved URL/URI formation from user locational information and the direct navigation character string.

2. State of the Art

The definitions at the web links below, hereby incorporated by reference, provide a brief introduction to a few important topics related to direct navigation discussed herein.

Direct Navigation http://en.wikipedia.org/wiki/Direct_navigation
Domain Name http://en.wikipedia.org/wiki/Domain_name
Top-Level Domain (TLD) http://en.wikipedia.org/wiki/Top-level_domain
Web Browser http://en.wikipedia.org/wiki/Web_browser
Geo-Location http://en.wikipedia.org/wiki/Geolocation
IP Address http://en.wikipedia.org/wiki/IP_address
URL http://en.wikipedia.org/wiki/Uniform_Resource_Locator
URI http://en.wikipedia.org/wiki/Uniform_Resource_Identifier
HTTP http://en.wikipedia.org/wiki/Http
HTTPS http://en.wikipedia.org/wiki/Https
SSL http://en.wikipedia.org/wiki/Secure_Sockets_Layer
Whois http://en.wikipedia.org/wiki/Whois
RealNames http://en.wikipedia.org/wiki/RealNames
URL/Address Bar http://en.wikipedia.org/wiki/URL_bar

### “I'm Feeling Lucky” ® http://en.wikipedia.org/wiki/I%27m_feeling_lucky

.EU http://en.wikipedia.org/wiki/.eu
.XXX http://en.wikipedia.org/wiki/.xxx
Network Session http://en.wikipedia.org/wiki/Session_%28computer_science%29

### Current Browser Functions

The state of the art of direct navigation is easily viewed through the new and improving functions of the latest network browsers, particularly the Firefox browser by Mozilla. Comparing direct navigation functionality from early web browsers through today, a slow evolution is apparent. These improvements stem from differing uses of the “Direct Navigation Character String” (the DNCS), i.e. the text appearing in the address bar of the browser, if an improperly formatted URL is entered by the user. The browser address bar location is depicted in FIG. 1 at 101.

An improperly formatted URL typically occurs when

1. a user fails to add a TLD, or

2. adds spaces to the URL, or

3. does not provide a proper protocol, such as HTTPS.

Currently, the most sophisticated browsers provide a modified version of the top-down list below to extrapolate URLs from improper formatted direct navigation character strings:

1. Custom Functions

2. Built-In or Special Functions

3. URL Construction

4. Connection Failure

Direct Navigation Character String “Custom Functions” describe user-defined mechanisms for use in newer-generation full-featured browsers. With this functionality, savvy users can create any number of tools to customize DNCS processing within a simple syntax structure. For example, a user might configure the DNCS “blog” to automatically redirect to their personal blog when entered into the browser. In a more advanced application of Custom Functionality, a user might configure a variable DNCS such as “whois domain_name” such that the resulting URL navigates to a website and performs a whois search on the supplied domain name.

As a result of user-centric preferences, it is normal for custom functions to be invoked/attempted prior to the other methods described herein. In many cases custom functions are attempted/performed through initial pattern matching of the DNCS with user-defined configurations. Other DNCS custom functions and methods will be apparent to those skilled in the art.

Direct Navigation Character String “Built-in Functions” or “Special Functions” describe browser-default or browser-authored DNCS functions, similar to the mechanisms of Custom Functions. The major difference is that these particular functions have been elevated by the browser software developer to a status that allows them to be distributed as default mechanisms on all browsers. For example, if a browser developer decided that the “whois” example above was applicable/useful to many users, the developer may “hard-code” the functionality into all future browser distributions.

As an example, Firefox has a built-in special mechanism that in many instances functions to pass the DNCS for processing to Google. Somewhat oversimplified, the special functionality of Firefox passes the DNCS to Google for an “I'm Feeling Lucky” type search and returns the results to the browser. However, it is important to realize that in this situation any intelligent direct navigation mechanisms are performed by Google, and not by the browser. Other DNCS built-in functions and methods will be apparent to those skilled in the art.

Direct Navigation Character String “URL Construction” describes attempts by the network browser to form a valid/navigable URL from a DNCS with no spaces. In most cases, this involves adding the TLD “.com” as a suffix to the DNCS and reattempting a connection. If this initial formation is unsuccessful, the browser may attempt to add the prefix “www.” to the DNCS, if it is not already present. Subsequent failures sometimes result in the same formation sequence attempted with the TLD “.net” instead.

Finally, Direct Navigation Character String “Connection Failure” describes the result when no valid function or URL can be created from the DNCS, as provided. At this point, all conceivable attempts to navigate to a valid URL have failed, or resulted in errors, and the browser is essentially “giving up” on any further tries. Typically this results in the display of an error message, such as “Server not Found” or “Unable to Connect.”

The present invention improves upon the “URL construction” mechanisms by analyzing the users location and direct navigation character string, as described further below.

The foregoing examples of the related art and limitations related therewith are intended to be illustrative and not exclusive. Other limitations of the related art will become apparent to those of skill in the art upon a reading of the specification and a study of the drawings.

### BRIEF DESCRIPTION OF THE DRAWINGS

Embodiments of the inventions are illustrated in the figures. However, the embodiments and figures are illustrative rather than limiting; they provide examples of the invention.

The invention, together with further advantages thereof, may best be understood by reference to the following description taken in conjunction with the accompanying drawings in which:

FIG. 1 is a suitable embodiment of a network browser;

FIG. 2 is a suitable embodiment of the invention;

FIG. 3 is a simplified embodiment of the invention.

### SUMMARY OF THE INVENTION

The following embodiments and aspects thereof are described and illustrated in conjunction with systems, tools, and methods that are meant to be exemplary and illustrative, not limiting in scope. In various embodiments, one or more of the above-described problems have been reduced or eliminated, while other embodiments are directed to other improvements.

According to the invention, improved browser navigation results from analyzing locational and/or lexical information associated with an instance of direct navigation, and intelligently constructing a more appropriate URL/URI. By analyzing a user's geographic location, the present invention may determine that a more suitable TLD (besides the default .com or .net) should be appended during the “URL construction” phase, as described herein. For example, with the recent successful launch of the European Union's “.eu” TLD, improved regionalized results may occur by appending .eu in European locations rather than assuming .com is the most relevant TLD. Similarly, by analyzing the keyword(s) associated with an instance of direct navigation, an alternate TLD or connection protocol/scheme may be chosen based on language origin, keyword definition, and/or keyword affiliation. For example, a lexical analysis of a direct navigation instance may determine that the keyword is undoubtedly adult-themed (or sexually explicit), and as such decide that the .xxx TLD is likely the most appropriate. In some cases, both locational and lexical information combined will determine an optimal TLD selection for URL construction.

The proposed system, method and device can offer, among other advantages, improved network integrity. This can be accomplished in an efficient and robust manner compared to other networks. Advantageously, the proposed system, method and device can identify and perform countermeasures against a variety of attacks, including, for example, wired network attacks, wireless network attacks, spoofing attacks, mac address masquerades and SSID masquerades. These and other advantages of the present invention will become apparent to those skilled in the art upon a reading of the following descriptions and a study of the several figures of the drawings.

### DETAILED DESCRIPTION OF THE INVENTION

In the following description, several specific details are presented to provide a thorough understanding of embodiments of the invention. One skilled in the relevant art will recognize, however, that the invention can be practiced without one or more of the specific details, or in combination with other components, etc. In other instances, well-known implementations or operations are not shown or described in detail to avoid obscuring aspects of various embodiments, of the invention.

While the invention as contemplated encompasses a general intelligent URL construction mechanism in direct navigation, a complete understanding of the invention is best achieved through the detailed description of a web browser implementation of TLD and protocol/scheme selection.

### Direct Navigation Character String

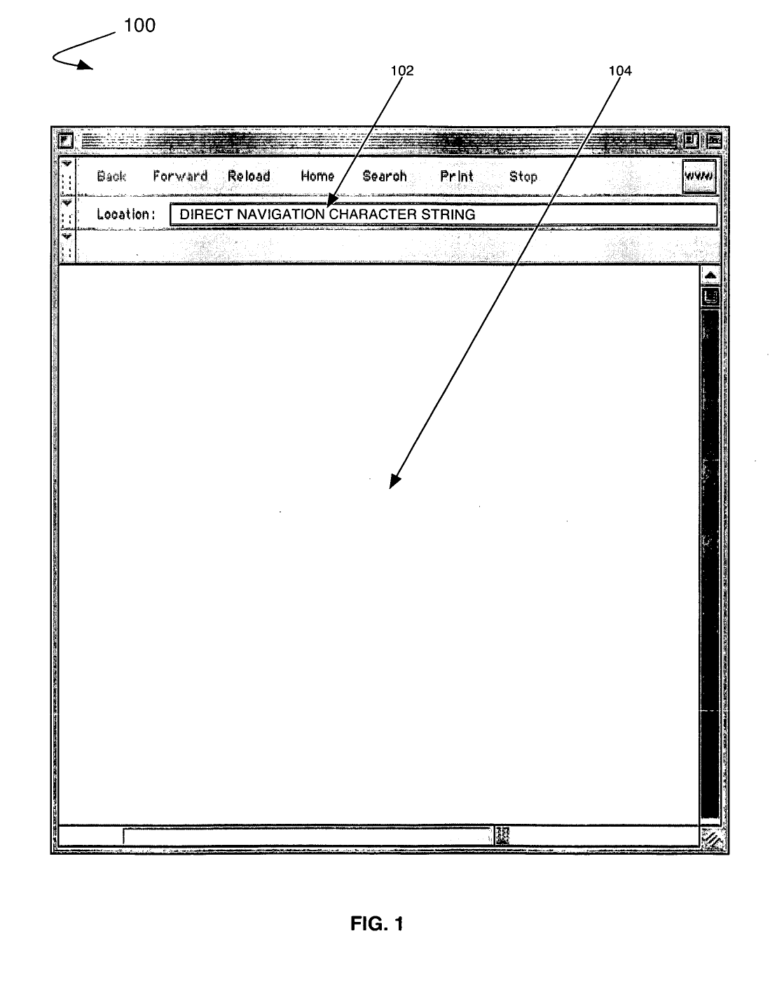

FIG. 1 depicts a network browser interface 100 and the components relevant to the current invention, 102 and 104. Element 102 represents the Direct Navigation Character String (DNCS) within the interface area typically known as the browser's “address bar.” Element 104 identifies the network browser content/display window. Functionality of the browser interface and related components will be apparent to those skilled in the art.

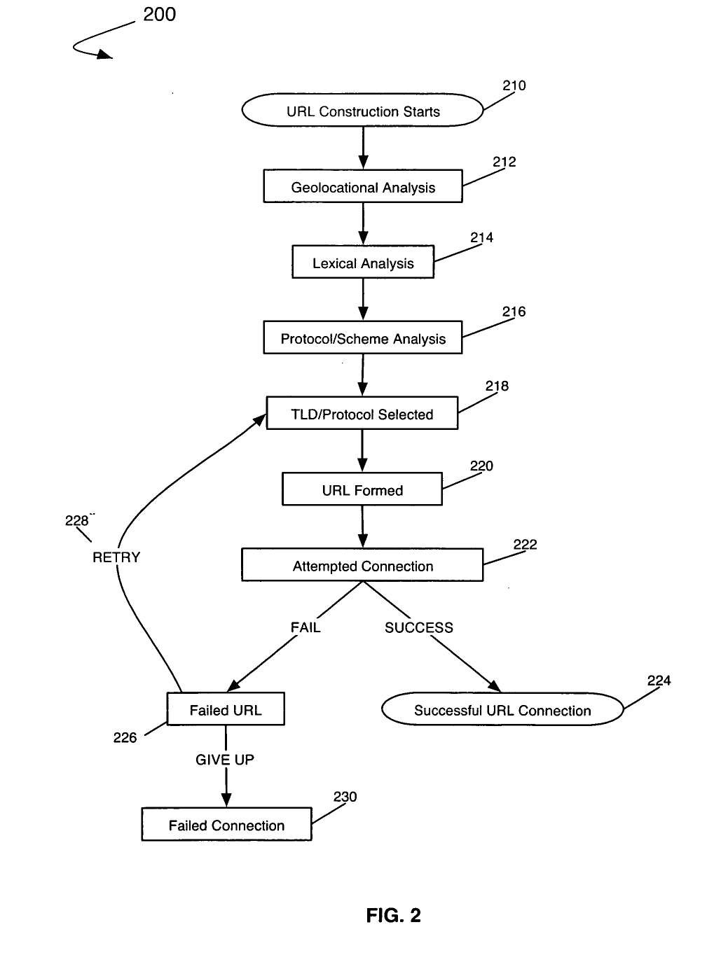

FIG. 2 depicts a block diagram 200 of the process flow of the invention. As the process begins at block 210, the URL construction phase starts, as described above. Necessary to this process, is a Direct Navigation Character String 102, as entered by the end-user. The process continues, as follows:

### Geolocational Analysis

Block diagram element 212 initiates a geolocational analysis of the network browser end-user. Typically this analysis would include 1) a geographic IP lookup to approximate the country, region, state and/or city of the end-user, and 2) built-in browser language/country information for additional consideration. Currently, there are a number of free and commercial services providing geographic IP lookup information. For efficiency reasons, a geolocational analysis can be performed only once per networked session, with the results being saved/cached for subsequent uses during the session. During a single network browser session, the geolocational analysis should remain static, only requiring re-analysis when new sessions are initiated. Specific methods of geographic IP lookup, browser language/country identification, and network session management will be apparent to those skilled in the art. Other methods of geolocational analysis will be apparent to those skilled in the art.

### Lexical Analysis

Block diagram element 214 initiates a lexical analysis of the Direct Navigation Character String 102. Currently, there are a number of companies that provide lexical/contextual services, or a custom lexical analysis engine can be established. Depending on the complexity of the analysis, different types of functionality are possible. For example, a lexical analysis might establish that the DNCS represents a word in a foreign language. Alternatively, the analysis might recognize that the DNCS is a generic word or phrase. Other forms of lexical analysis will be apparent to those skilled in the art.

### Protocol/Scheme Analysis

Block diagram element 216 initiates a protocol analysis of the Direct Navigation Character String 102. One embodiment parses the DNCS for certain keywords that indicate an alternative protocol to be used during URL formation besides the default HTTP. For example, the keywords “secure” or “ssl” often indicate that the proper protocol for the formed URL is HTTPS. Similarly, the keyword “ftp” frequently indicates that the proper protocol for the formed URL is FTP. Other methods of protocol analysis will be apparent to those skilled in the art.

### TLD/Protocol Selection and URL Formation

Block element 218 starts the TLD and/or Protocol selection process, ultimately resulting in URL formation at 220. The selection process is likely to be simple rule-based logic, augmented with more advanced artificial intelligence, such as neural networks, as real-world use provides supplemental data. Several simple selection rules are previously described herein, including regional TLD substitution (TLD .eu instead of .com), adult content filtering (TLD xxx instead of .com), and secure protocol awareness (URI scheme https instead of http). Other selection and optimization rules will be apparent to those skilled in the art.

Based on the previous geolocational 212, lexical 214, and protocol 216 analyses, the system 200 selects and constructs 220 an optimized URL for a connection attempt 222. Simplistically, URL formation consists of concatenating the various components, namely the protocol, the DNCS, and the TLD, into a proper format. If necessary, spaces and/or punctuation are also removed from the DNCS to form a valid URL. Other methods of URL formation/construction will be apparent to those skilled in the art.

### Connection Attempts

Block diagram element 222 attempts a connection to the URL formed at 220. If the connection is successful 224, the process sequence finishes and a valid and accessible URL/URI is loaded in the browser display 104. If the connection attempt is not successful 226, there are two options. If possible, the system 200 may re-attempt 228 URL formation with an alternative TLD, an alternative protocol, and/or a modified DNCS (i.e. adding “www.” to the DNCS). If the system 200 has exhausted various combinations of URL formation without a successful connection, the final result is a failed connection 230.

### A Simplified Example

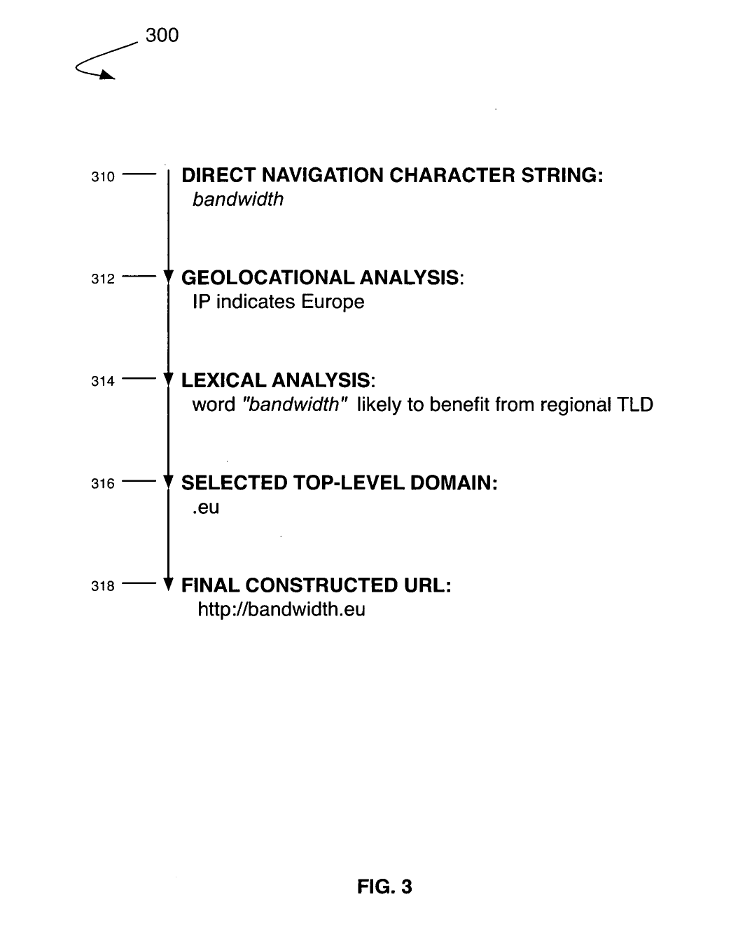

FIG. 3 depicts a sample process summary 300 of an embodiment of the invention. At step 310 the system receives the Direct Navigation Character String “bandwidth” for analysis. At step 312 the geolocational analysis determines that the end-user is connecting from Europe. At step 314 the lexical analysis determines that the word “bandwidth” is a generic technical phrase with international applicability. At step 316 the results from the previous two steps are used to determine an appropriate TLD for URL formation. In this instance, the TLD “.eu” is selected as a better candidate than “.com” for this end-user located in Europe. Finally, at step 318 the final URL “http://bandwidth.eu” is constructed by piecing together (a) the selected protocol “http” (b) the DNCS “bandwidth” and (c) the selected top-level domain “.eu”.

As used herein, the terms “embodiment” and “example” mean an embodiment that serves to illustrate by way of example but not limitation.

It will be appreciated to those skilled in the art that the preceding examples and embodiments are exemplary and not limiting to the scope of the present invention. It is intended that all permutations, enhancements, equivalents, and improvements thereto that are apparent to those skilled in the art upon a reading of the specification and a study of the drawings are included within the true spirit and scope of the present invention. It is therefore intended that the following appended claims include all such modifications, permutations and equivalents as fall within the true spirit and scope of the present invention.

What is claimed is:

1. A method for intelligent direct navigation, comprising:
a) requesting URL formation from a direct navigation character string;
b) analyzing user location and/or performing a lexical analysis of the character string;
c) selecting a top-level domain and/or protocol based on results of locational/lexical analysis; and
d) constructing a URL from the character string, protocol and/or selected top-level domain.

2. A method as recited in claim 1, wherein a user is located in Europe and .eu is selected as the top-level domain.

3. A method as recited in claim 1, wherein a user is located in Australia and .au is selected as the top-level domain.

4. A method as recited in claim 1, wherein the character string includes an adult word and .xxx is selected as the top-level domain.

5. A method as recited in claim 1, wherein the character string includes secure and an https protocol is selected.

6. A method as recited in claim 1, wherein the character string includes ssl and an https protocol is selected.

7. A method as recited in claim 1, wherein the character string includes a foreign word and a top-level domain representing the foreign word's country of origin is selected.

8. A system for intelligent direct navigation, comprising:
a) means for requesting URL formation from a direct navigation character string;
b) means for analyzing user location and/or performing a lexical analysis of the character string;
c) means for selecting a top-level domain and/or protocol based on results of locational/lexical analysis; and
d) means for constructing a URL from the character string, protocol and/or selected top-level domain.

9. A system as recited in claim 7, wherein a user is located in Europe and .eu is selected as the top-level domain.

10. A system as recited in claim 7, wherein a user is located in Australia and .au is selected as the top-level domain.

11. A system as recited in claim 7, wherein the character string includes an adult word and .xxx is selected as the top-level domain.

12. A system as recited in claim 7, wherein the character string includes secure and/or ssl and an https protocol is selected.

13. A system as recited in claim 7, wherein the character string includes a foreign word and a top-level domain representing the foreign word's country of origin is selected.

14. A computer program embodied on a computer readable medium for intelligent top-level domain selection in direct navigation, comprising:
a) a URL formation module for requesting URL formation from a direct navigation character string;
b) an analysis module for analyzing user location and/or performing a lexical analysis of the character string;
c) a TLD module for selecting a top-level domain and/or protocol based on results from the analysis module; and
d) a construction module for constructing a URL from the character string, protocol and/or selected top-level domain.

15. A computer program as recited in claim 13, wherein a user is located in Europe and .eu is selected as the top-level domain.

16. A computer program as recited in claim 13, wherein a user is located in Australia and .au is selected as the top-level domain.

17. A computer program as recited in claim 13, wherein the character string includes an adult word and xxx is selected as the top-level domain.

18. A computer program as recited in claim 13, wherein the character string includes secure and an https protocol is selected.

19. A computer program as recited in claim 13, wherein the character string includes ssl and an https protocol is selected.

20. A computer program as recited in claim 13, wherein the character string includes a foreign word and a top-level domain representing the foreign word's country of origin is selected.
